(19) United States
(12) Patent Application Publication
(10) Pub. No.: US 2012/0025589 A1
(43) Pub. Date: Feb. 2, 2012

(54) SAFETY SEATBELT SYSTEM FOR PREGNANT WOMEN

(76) Inventor: Pete Calderon, JR., Mission Viejo, CA (US)

(21) Appl. No.: 13/182,967

(22) Filed: Jul. 14, 2011

Related U.S. Application Data
(60) Provisional application No. 61/369,827, filed on Aug. 2, 2010.

(51) Int. Cl. B60R 22/00; B60R 22/14

(52) U.S. Cl. 297/485

(57) ABSTRACT

A safety seatbelt system for pregnant women comprising: a ballistic nylon webbing restraint harness having a profile providing an open abdominal area for accommodating a developing fetus within the pregnant passenger; an attachment strap having a male end and a female end that wraps around a posterior region of a seat in a vehicle; a D-ring bracket; a neck engaging portion, such that a chest of the pregnant passenger is suitably restrained from forward movement in the event of a collision; at least two threadable clips to provide side adjustment; and a back strap. The restraint harness has a top female end and a bottom female end along with a male end. The restraint harness provides attachment points on both bottom sides of the restraint harness such that the restraint harness can be removably affixed to the OEM seatbelt assembly in the vehicle.

### CROSS-REFERENCE TO RELATED APPLICATION

The present application is related to and claims priority from prior provisional application Ser. No. 61/369,827, filed Aug. 2, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of seatbelt harnesses and more specifically relates to a seatbelt harness for use on pregnant women to prevent the death or injury to unborn fetuses during vehicular accidents.

### 2. DESCRIPTION OF THE RELATED ART

A seatbelt, sometimes called a safety belt, is a safety harness designed to secure the occupant of a vehicle against harmful movement that may result from a collision or a sudden stop. As part of an overall automobile passive safety system, seat belts are intended to reduce injuries by stopping the wearer from hitting hard interior elements of the vehicle, or other passengers (the so-called second impact), are in the correct position for the airbag to deploy and prevent the passenger from being thrown into the windshield or from the vehicle. Seat belts also absorb energy by being designed to stretch during sudden deceleration, so that there is less speed differential between the passenger's body and their vehicle interior, and also to spread the loading of impact on the passenger's body. There are many short-comings in current seatbelt systems.

Pregnancy is the carrying of one or more offspring, known as a fetus or embryo, inside the womb of a female. In a pregnancy, there can be multiple gestations, as in the case of twins or triplets. Childbirth usually occurs about 38 weeks after conception; in women who have a menstrual cycle length of four weeks, this is approximately 40 weeks from the last normal menstrual period (LNMP). During this time expectant mothers may be travelling using seatbelts, causing potential danger to the developing fetus.

Individuals should always wear a seatbelt, even while pregnant. However, wearing a lap belt across one's pregnant stomach can be dangerous. In the event of an accident, the lap belt could potentially cause severe harm to the unborn child. The belt is often positioned directly over the top of the baby, and in a collision can cause trauma to the child. Death is even a possibility depending on the severity of the accident and the position of the lap belt. Pregnant women are often uncomfortable with the idea of not wearing a seatbelt, but also want to protect their child from seatbelt trauma. A more efficient seatbelt option is needed.

Various attempts have been made to solve the above-mentioned problems such as those found in U.S. Pat. No. 5,215,354; Pub. Nos. 2002/0140279; 2005/0110316; U.S. Pat. Nos. 5,005,865; 6,935,700; 4,610,463; and 5,915,789. This prior art is representative of seatbelts. None of the above inventions and patents, taken either singly or in combination, is seen to describe the invention as claimed.

Ideally, a safety seatbelt system for pregnant women should be safe, user-friendly, easy to install and yet, would operate reliably and be manufactured at a modest expense. Thus, a need exists for a reliable safety seatbelt system for pregnant women that protects unborn fetuses in the event of a vehicular accident.

### BRIEF SUMMARY OF THE INVENTION

In view of the foregoing disadvantages inherent in the known seatbelt harness art, the present invention provides a novel safety seatbelt system for pregnant women. The general purpose of the present invention, which will be described subsequently in greater detail, is to provide a safety seatbelt usable by pregnant women that protects unborn fetuses in the event of a vehicular accident.

The present invention, safety seatbelt system for pregnant women as disclosed herein preferably comprises: a ballistic nylon webbing restraint harness having a profile providing an open abdominal area for accommodating a developing fetus within the pregnant passenger; an attachment strap having a male end and a female end that wraps around a posterior region of a seat in a vehicle; a D-ring bracket; a neck engaging portion, such that a chest of the pregnant passenger is suitably restrained from forward movement in the event of a collision; and at least two threadable clips to provide side adjustment. The harness has a top female end and a bottom female end along with a male end for suitable attachment.

Further, the restraint harness preferably comprises a back strap. The restraint harness provides attachment points on both bottom sides of the restraint harness such that the restraint harness can be removably affixed to the OEM (original equipment manufacture) seatbelt assembly in the vehicle. As a result the restraint harness provides at least three attachment points to the OEM seatbelt assembly in the vehicle.

The profile providing an open abdominal area comprises an approximately 10-inch by 4-inch lower abdominal elastic strap, circumventing the developing fetus. The profile of the restraint harness is given a larger surface area of contact with the pregnant passenger, thereby directing force around where the developing fetus is growing to provide a safety zone for the fetus. The abdominal area for accommodating a developing fetus is circular substantially contour molding around a perimeter of the developing fetus thereby circumventing the fetus and directing the impact forces to other locations. The restraint harness further comprises a 2-inch webbing back strap to distribute forces/stresses incurred by the safety harness over an increased surface area also providing comfort to the pregnant passenger.

The D-ring bracket located on the restraint harness permits the restraint harness to be adjustable and accommodate a relative size of the developing fetus within the confines of the mother. The restraint harness further preferably comprises a neck engaging portion such that a chest of the pregnant passenger is suitably restrained from forward movement in the event of a collision. The neck engaging portion comprises a V-profile within preferred embodiments.

A kit is also embodied herein for the safety seatbelt for pregnant women system comprising: a restraint harness; at least one attachment strap; and a set of user instructions for installation and use.

In accordance with the embodiments of the present invention a preferred method of use is disclosed herein preferably comprising: step one, placing a restraint harness over a head of a pregnant passenger; step two, removeably-attaching a female end of the restraint harness to a male end of an OEM seatbelt assembly in a vehicle; step three, removeably-attaching a bottom female end to the male end of the attachment strap; step four, wrapping the attachment strap around a posterior region of a seat; step five, removeably-attaching the female end of the attachment strap to a male end on the restraint harness; step six, adjusting the restraint harness around a periphery of a developing fetus within the pregnant passenger; and step seven, adjusting the restraint harness via a D-ring bracket to a user-preferred tightness thereby securing the pregnant passenger (and the unborn fetus) safely into the seat of the vehicle.

The present invention holds significant improvements and serves as a safety seatbelt system for pregnant women. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, safety seatbelt system for pregnant women, constructed and operative according to the teachings of the present invention.

FIG. 1 shows a perspective view illustrating a safety seatbelt system for pregnant women in an ‘in-use’ condition according to an embodiment of the present invention.

FIG. 2 shows another perspective view illustrating the safety seatbelt system for pregnant women in the ‘in-use’ condition according to an embodiment of the present invention.

FIG. 3A shows a front perspective view illustrating a restraint harness removeably-attached to a pregnant passenger of the safety seatbelt system for pregnant women according to an embodiment of the present invention.

FIG. 3B shows a side perspective view illustrating the restraint harness removeably-attached to the pregnant passenger of the safety seatbelt system for pregnant women according to an embodiment of the present invention.

FIG. 4A shows another side perspective view illustrating the restraint harness removeably-attached to the pregnant passenger of the safety seatbelt system for pregnant women according to an embodiment of the present invention.

FIG. 4B shows a back perspective view illustrating the restraint harness removeably-attached to the pregnant passenger of the safety seatbelt system for pregnant women according to an embodiment of the present invention.

FIG. 5A shows a front perspective view illustrating the restraint harness of the safety seatbelt system for pregnant women according to an embodiment of the present invention.

FIG. 5B shows another perspective view illustrating the restraint harness and the attachment strap of the safety seatbelt system for pregnant women according to an embodiment of the present invention.

FIG. 6 shows a perspective view illustrating the restraint harness removably-coupleable to an OEM seatbelt assembly of the safety seatbelt system for pregnant women according to an embodiment of the present invention.

FIG. 7 is a flowchart illustrating a method of use for the safety seatbelt system for pregnant women according to an embodiment of the present invention of FIGS. 1-6.

The various embodiments of the present invention will hereinafter be described in conjunction with the appended drawings, wherein like designations denote like elements.

### DETAILED DESCRIPTION

As discussed above, embodiments of the present invention relate to field of seatbelt harnesses and more specifically relates to a seatbelt harness for use on pregnant women to prevent the death or injury of unborn fetuses in vehicular accidents.

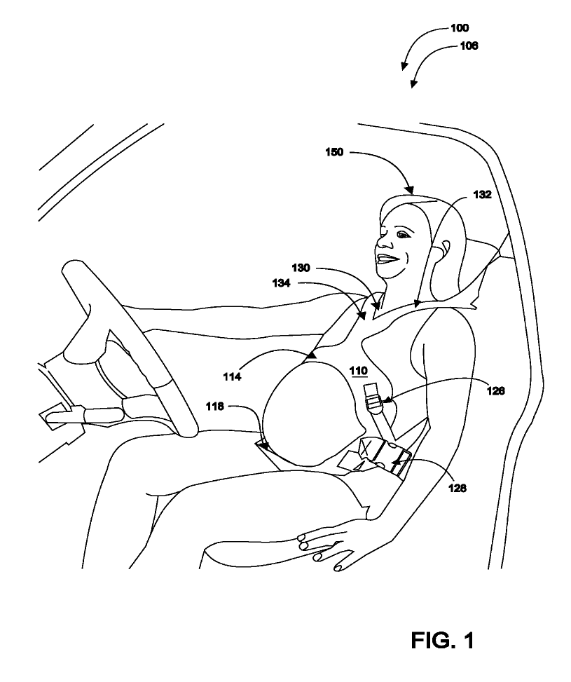

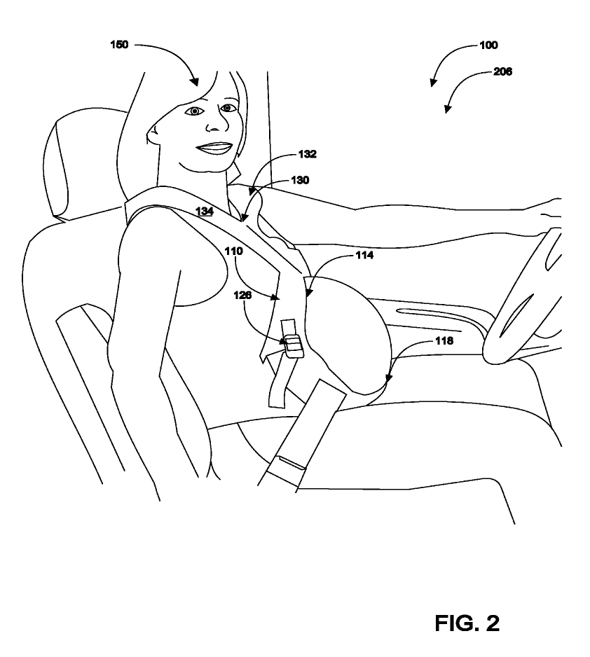

Referring now to FIGS. 1-2 showing perspective views of safety seatbelt system for pregnant women 100 in ‘in-use’ condition 106 and ‘in-use’ condition 206 according to embodiments of the present invention. Safety seatbelt system for pregnant women 100 preferably comprises an attachment for existing (OEM) vehicle seatbelts that may be designed to prevent the death or injury of unborn fetuses in car accidents. Pregnant passenger 150 may use this novel safety device in their vehicles to provide supplemental protection to the stomach area in the event of an accident. Furthermore, safety seatbelt system for pregnant women 100 improves upon the traditional lap belt by dispensing forces of impact, which can limit harm to the fetus (and expectant mother) during a collision.

Safety seatbelt system for pregnant women 100 preferably comprises restraint harness 110. Restraint harness 110 preferably includes profile providing open abdominal area 114 for accommodating a developing fetus within pregnant passenger 150. Restraint harness 110 preferably comprises webbing. The webbing may be of the type 1680 ballistic nylon webbing. Upon reading this specification, it should be appreciated that, under appropriate circumstances, considering such issues as user preferences, design preference, structural requirements, marketing preferences, cost, available materials, technological advances, etc., other webbing configurations or types of nylon, various suitable fabrics, etc., may be sufficient.

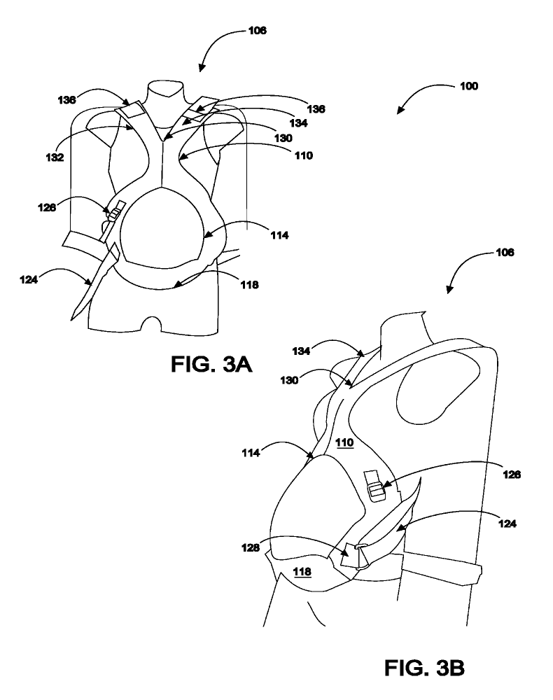

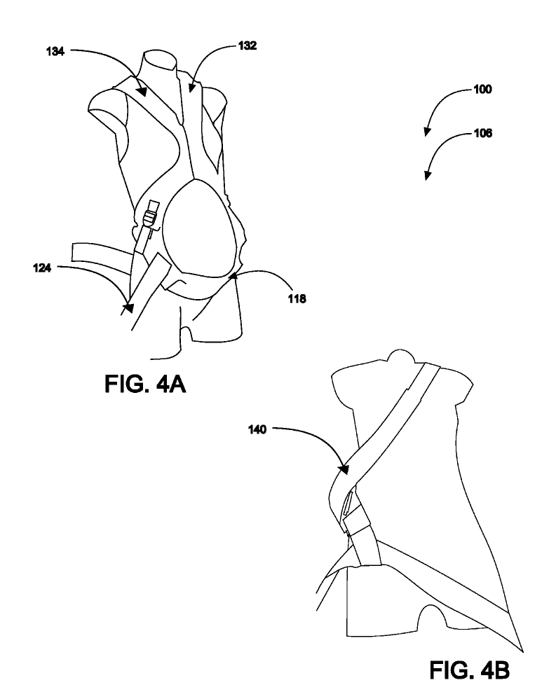

Referring now to FIGS. 3A-4B showing perspective views illustrating restraint harness 110 removeably-attached to pregnant passenger 150 of safety seatbelt system for pregnant women 100 according to an embodiment of the present invention.

Profile providing an open abdominal area 114 of restraint harness 110 preferably circumvents the developing fetus. Circumvention of the developing fetus is accomplished by the profile providing an open abdominal area 114 for accommodating the developing fetus being circular, substantially contour molding (conforming to the shape) around a perimeter of the developing fetus. Additionally profile provides open abdominal area 114 preferably comprises about a 20-inch circumference when in a non-use condition.

A primary benefit of having circumvention of the developing fetus when safety seatbelt system for pregnant women 100 is in in-use condition 106 or in-use condition 206, on pregnant passenger 150 is that restraint harness 110 restraint harness is given a larger surface area of contact with pregnant passenger 150 thereby directing force around where the developing fetus is growing to provide a safety zone for the developing fetus as shown best in FIG. 2.

As mentioned previously, profile provides open abdominal area 114 and may further comprise an approximately 10-inch by about 4-inch lower abdominal elastic strap 118. Lower abdominal elastic strap 118 preferably provides greater ‘give’ when the developing fetus of pregnant passenger 150 begins to mature and reaches the later stages of pregnancy by providing less pressure on the lower abdomen of pregnant passenger 150.

Located on an upper half of profile, providing an open abdominal area 114 on restraint harness 110, may be two adjusters 126 to provide slight loosening and tightening of upper half of the profile providing an open abdominal area 114 on restraint harness 110 by pulling a strap threaded through adjuster(s) 126 tighter or looser. Located on a lower half of profile providing an open abdominal area 114 on restraint harness 110 may be at least two threadable clips 128 to provide side adjustment for a growing fetus especially during the last trimester of a pregnancy as shown best in FIGS. 3A-4A. Threadable clips 128 may be used in conjunction with a hook and loop fastener system (or other suitable fastening means). Strap(s) 124 comprising both a hook portion and a loop portion may be threaded through threadable clips 128 to a user-chosen desired level of tightness and then removeably-fastened with the hook and loop portion of strap 124 mating to provide a user-adjustable fastening system.

Restraint harness 110 further comprises neck engaging portion 130, such that a chest portion of pregnant passenger 150 is suitably restrained from forward movement in the event of a collision. Neck engaging portion 130 preferably comprises a V-profile (may comprise a U-shape or other in alternate embodiments) having a left neck engaging strap 132 and right neck engaging strap 134 as shown best in FIG. 3A. Neck engaging portion 130 may comprise a hook and loop fastening system. The hook and loop fastening system includes an approximately 3-inch long hook portion located on the top of each V-profile strap with an approximately 6-inch loop portion on the lower end of both left neck engaging strap 132 and right neck engaging strap 134. Neck engaging portion 130 preferably further comprises D-ring bracket(s) 136. D-ring bracket(s) 136 may be located on both left neck engaging strap 132 and right neck engaging strap 134 to allow the hook and loop portion of left neck engaging strap 132 and right neck engaging strap 134 to mate thereby fastening neck engaging portion onto pregnant passenger 150. A benefit of using D-ring bracket 136 is to permit restraint harness 110 to be adjustable around a chest and shoulder region of pregnant passenger 150 and accommodate a relative size of the developing fetus.

Restraint harness further comprises back strap 140. Back strap 140 may include a 2-inch webbing strap to preferably distribute tension caused by resistance to forward movement by restraint harness over an increased surface area thereby also providing comfort (and safety) to pregnant passenger 150 as shown in FIG. 4B.

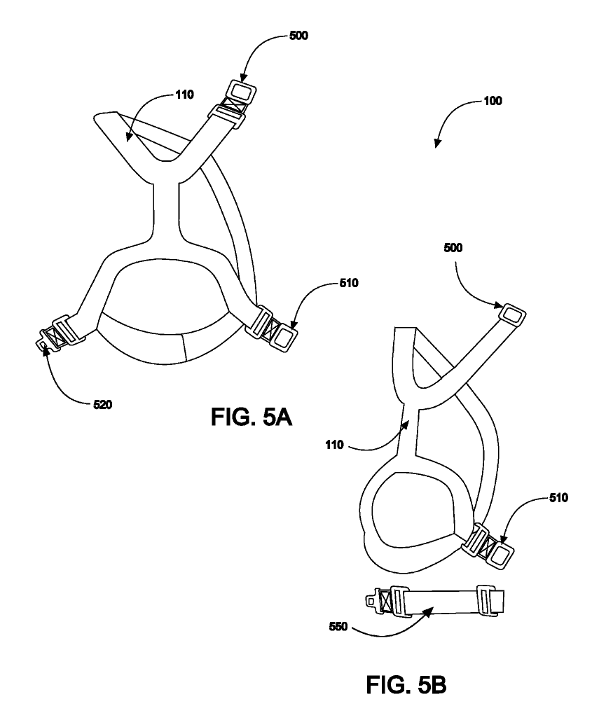

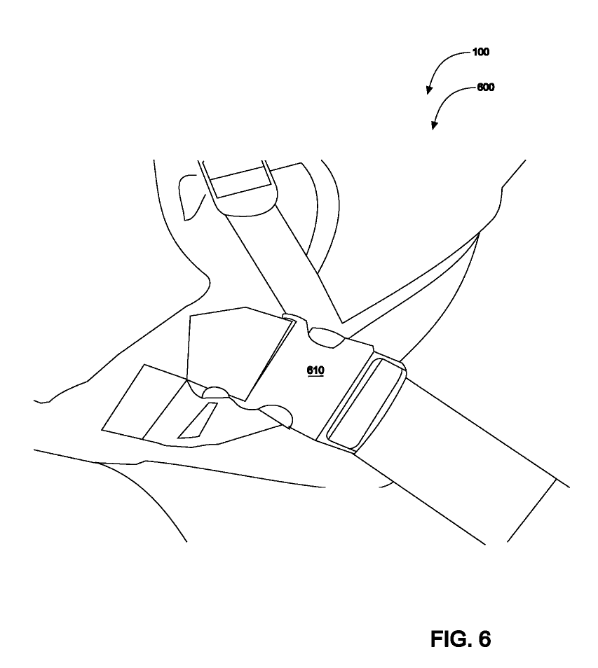

Referring now to FIG. 5A-6 showing perspective views illustrating restraint harness 110 of safety seatbelt system for pregnant women 100 according to an embodiment of the present invention.

Restraint harness 110 provides attachment points on both bottom sides of restraint harness 110 such that said restraint harness 110 can be removably affixed to OEM seatbelt assembly 600 in the vehicle. OEM seatbelt assembly 600 may absorb energy by being designed to stretch during virtually any sudden deceleration, so that there is less velocity differential between the vehicle interior, and also to spread the loading of impact on body of pregnant passenger 150.

Additionally, restraint harness 110 preferably provides at least three attachment points to OEM seatbelt assembly 600 in the vehicle. Safety seatbelt for pregnant women system 100 further comprises attachment strap 550. Attachment strap 550 has male end 554 and female end 558 that preferably wrap around a posterior region of a seat (bucket or bench) in a vehicle as shown in FIG. 6B. Restraint harness 110 preferably comprises top female end 500, bottom female end 510, and male end 520. Top female end 500 is preferably removably-attachable to male end 610 of OEM seatbelt assembly 600 in a vehicle. Bottom female end 510 is preferably removably-attachable to male end 554 of attachment strap 550 and then wrapped around a posterior region of a vehicle seat and then female end 558 of attachment strap 550 is removably-attached to male end 520 on restraint harness 110 thereby securing pregnant passenger 150 safely into the seat of the vehicle.

Safety seatbelt system for pregnant women 100 according to embodiments of the present invention of FIGS. 1-6 may comprise kit 640. Kit 640 may comprise the following parts: restraint harness 110; at least one attachment strap 550; and a set of user instructions for installation and use.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different anchoring combinations, parts may be sold separately.

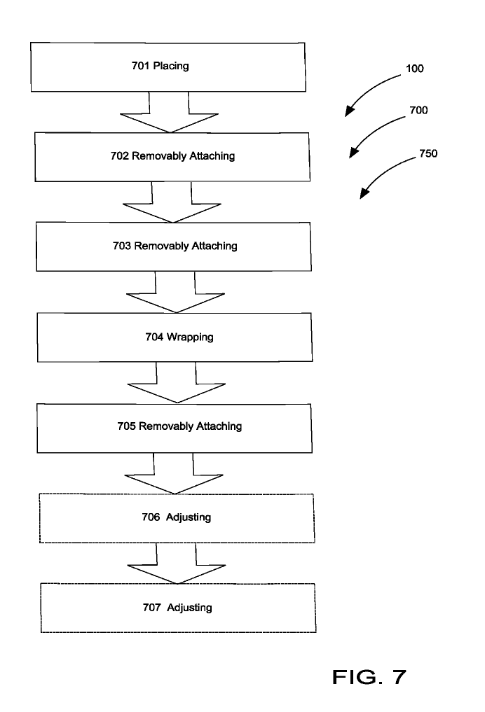

Referring now to FIG. 7, showing flowchart 750 illustrating method of use 700 according to an embodiment of the present invention of FIGS. 1-6. A method of using (at least herein enabling method of use 700) safety seatbelt system for pregnant women 100 may comprise the steps of: step one 701 placing restraint harness 110 over a head of pregnant passenger 150; step two 602 removeably-attaching top female end 500 of restraint harness 110 to male end 610 of OEM seatbelt assembly 600 in a vehicle; step three 603 removeably-attaching bottom female end 510 to male end 554 of attachment strap 550; step four 604 wrapping attachment strap 550 around a posterior region of a seat; step five 605 removeably-attaching female end 558 of attachment strap 550 to male end 520 on restraint harness 110; step six 606 adjusting restraint harness 110 around a periphery of a developing fetus with pregnant passenger 150; and step seven 607 adjusting restraint harness 110 via a D-ring bracket(s) 136 to a user-preferred tightness thereby securing pregnant passenger 150 safely into the seat of the vehicle.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A safety seatbelt system for use by pregnant passengers comprising:
a restraint harness having a profile providing an open abdominal area for accommodating a developing fetus within said pregnant passenger;
said harness having a top female end and a bottom female end;
said harness having a male end; and
an attachment strap having a male end and a female end that wraps around a posterior region of a seat in a vehicle;
wherein said top female end is removably-attachable to a male end of an OEM seatbelt assembly in said vehicle;
wherein said bottom female end is removably-attachable to said male end of said attachment strap and then wrapped around said posterior region of said seat and then said female end of attachment strap is removably-attached to said male end on said harness thereby securing said pregnant passenger safely into said seat of said vehicle.

2. The safety seatbelt system for use by pregnant passengers of claim 1 wherein said restraint harness further comprises at least one D-ring bracket.

3. The safety seatbelt system for use by pregnant passengers of claim 2 wherein said D-ring bracket permits said restraint harness to be adjustable and accommodate a relative size of said developing fetus.

4. The safety seatbelt system for use by pregnant passengers of claim 1 wherein said restraint harness further comprises ballistic nylon webbing.

5. The safety seatbelt system for use by pregnant passengers of claim 1 wherein said profile providing an open abdominal area comprises an approximately 10-inch by about 4-inch lower abdominal elastic strap.

6. The safety seatbelt system for use by pregnant passengers of claim 1 wherein said profile providing an open abdominal area of restraint harness circumvents said developing fetus.

7. The safety seatbelt system for use by pregnant passengers of claim 6 wherein said circumvention of said developing fetus of restraint harness is given a larger surface area of contact with said pregnant passenger thereby directing force around where said developing fetus is growing to provide a safety zone for said developing fetus.

8. The safety seatbelt system for use by pregnant passengers of claim 1 wherein said restraint harness further comprises a 2-inch webbing back strap to distribute tension of said safety harness over an increased surface area providing comfort and safety to said pregnant passenger.

9. The safety seatbelt system for use by pregnant passengers of claim 7 wherein said abdominal area for accommodating a developing fetus is circular substantially contour molding around a perimeter of said developing fetus thereby circumventing said developing fetus.

10. The safety seatbelt system for use by pregnant passengers of claim 1 further comprising a neck engaging portion, such that a chest of said pregnant passenger is suitably restrained from forward movement in the event of a collision.

11. The safety seatbelt system for use by pregnant passengers of claim 10 wherein said neck engaging portion comprises a V-profile.

12. The safety seatbelt system for use by pregnant passengers of claim 1 further comprising at least two threadable clips to provide side adjustment.

13. The safety seatbelt system for use by pregnant passengers of claim 4 wherein said restraint harness comprises webbed material providing a webbing.

14. The safety seatbelt system for use by pregnant passengers of claim 13 wherein said webbing comprises 1680 ballastic nylon.

15. The safety seatbelt system for use by pregnant passengers of claim 1 wherein said restraint harness comprises a back strap.

16. The safety seatbelt system for use by pregnant passengers of claim 1 wherein said restraint harness provides attachment points on both bottom sides of said restraint harness such that said restraint harness can be removably affixed to said OEM seatbelt assembly in said vehicle.

17. The safety seatbelt system for use by pregnant passengers of claim 1 wherein said restraint harness provides at least three attachment points to said OEM seatbelt assembly in said vehicle.

18. A safety seatbelt system for use by pregnant passengers comprising:
a 1680 ballistic nylon webbing restraint harness having a profile providing an open abdominal area for accommodating a developing fetus within said pregnant passenger;
a restraint harness having a top female end and a bottom female end;
said restraint harness having a male end;
an attachment strap having a male end and a female end that wraps around a posterior region of a seat in a vehicle;
a D-ring bracket;
a neck engaging portion, such that a chest of said pregnant passenger is suitably restrained from forward movement in the event of a collision; and
at least two threadable clips;
wherein said restraint harness comprises a back strap;
wherein said restraint harness provides attachment points on both bottom sides of said restraint harness such that said restraint harness can be removably affixed to said OEM seatbelt assembly in said vehicle;
wherein said restraint harness provides at least three attachment points to said OEM seatbelt assembly in said vehicle;
wherein said top female end is removably-attachable to a male end of an OEM seatbelt assembly in said vehicle;
wherein said bottom female end is removably-attachable to said male end of said attachment strap and then wrapped around said posterior region of said seat and then said bottom female end of attachment strap is removably-attached to said male end on said restraint harness thereby securing said pregnant passenger safely into said seat of said vehicle;
wherein said D-ring bracket permits said restraint harness to be adjustable and accommodate a relative size of said developing fetus;
wherein said profile provides an open abdominal area of restraint harness circumventing said developing fetus thereby providing a larger surface area of contact with said pregnant passenger and directs impact force(s) around where said developing fetus is growing to provide a safety zone for said developing fetus;
wherein said restraint harness further comprises a 2-inch webbing back strap to distribute tension of said safety harness over an increased surface area providing comfort to said pregnant passenger;
wherein said abdominal area for accommodating said developing fetus is circular substantially contour molding around a perimeter of said developing fetus thereby circumventing said developing fetus;
wherein said neck engaging portion comprises a V-profile;
wherein said threadable clips provide side adjustment; and
said harness thereby securing said pregnant passenger safely into said seat of said vehicle.

19. The safety seatbelt system for use by pregnant passengers of claim 18 further comprising a kit including said restraint harness; at least one attachment strap; and a set of user instructions for installation and use.

20. A method of using a safety seatbelt system for use by pregnant passengers comprising the steps of:
placing a restraint harness over a head of a pregnant passenger;
removeably-attaching a top female end of said restraint harness to a male end of an OEM seatbelt assembly in a vehicle;
removeably-attaching a bottom female end to said male end of said attachment strap;
wrapping said attachment strap around a posterior region of a seat;
removeably-attaching said bottom female end of said attachment strap to a male end on said restraint harness;
adjusting said restraint harness around a periphery of a developing fetus with said pregnant passenger; and
adjusting said restraint harness via a D-ring bracket to a user-preferred tightness thereby securing said pregnant passenger safely into said seat of said vehicle.
